(19) United States
(12) Patent Application Publication
(10) Pub. No.: US 2023/0198991 A1
(43) Pub. Date: Jun. 22, 2023

(54) FILE-BASED CONFIGURATION OF ACCESS MANAGEMENT

(71) Applicant: SAP SE, Walldorf (DE)

(72) Inventors: Johann Boehme, Berlin (DE); Dirk Malchow, Berlin (DE); Jonas Umland, Berlin (DE); Cora Glass, Berlin (DE)

(21) Appl. No.: 17/559,160

(22) Filed: Dec. 22, 2021

(51) Int. Cl. H04L 9/40; H04L 41/0859

(52) U.S. Cl. CPC H04L 63/102; H04L 63/105; H04L 41/0859

(57) ABSTRACT

Systems and methods include identification of a file defining a configuration associated with an access manager storing roles and profiles for accessing a plurality of cloud providers, determination that the file has changed and, in response to the determination, determine a current configuration of the access manager, determine a new configuration defined by the changed file, determine configuration changes based on the current configuration and the new configuration, and instruct the access manager to apply the configuration changes.

### BACKGROUND

Modern organizations often utilize a system landscape consisting of computing services provided by a plurality of geographically-distant computing systems. For example, in order to achieve desired functionality, an organization may deploy services within on-premise data centers (which themselves may be located in disparate geographic locations) and within data centers provided by one or more infrastructure as-a-service (i.e., cloud) providers.

Access managers are used to facilitate identity management and security entitlements across multiple systems and services. Typically, an administrator uses a graphical user interface provided by an access manager to manually configure roles and profiles, to associate the roles and profiles with one or more cloud providers and services, and to associate users with the roles and profiles. Generally, profiles determine the objects, fields, etc. which a user may access, and roles determine the records which a user is able to access.

The above-described manual configuration is time-consuming and introduces the possibility of human error. Resolution of a configuration error is also performed manually, leading to lost productivity and potential additional error.

What is needed are systems to facilitate automated configuration of an access manager. Such systems may include features to reduce configuration error, and to assist with the efficient resolution of configuration errors.

### BRIEF DESCRIPTION OF THE DRAWINGS

FIG. 1 is a block diagram of an architecture to automate configuration of an access manager according to some embodiments.

FIG. 2 is a block diagram of an architecture to utilize a configured access manager according to some embodiments.

FIG. 3 comprises a flow diagram of a process to configure an access manager according to some embodiments.

FIG. 4 is a block diagram of an architecture to automate approval of configuration changes and configuration of an access manager based on the approved changes according to some embodiments.

FIG. 5 is a sequence diagram of a process to approve of and apply configuration changes according to some embodiments.

FIG. 6 is a block diagram of a hardware system according to some embodiments.

### DETAILED DESCRIPTION

The following description is provided to enable any person in the art to make and use the described embodiments. Various modifications, however, will be readily-apparent to those in the art.

According to some embodiments, a configuration file defines a configuration of an access manager. Such a configuration file may include source code written in a declarative configuration language. The configuration file may be managed by a version control system which, for example, provides for check-in of changed files and version control of prior versions.

An automated file-based configuration system detects changes to a configuration file and, in response, executes a configuration tool to conform the configuration (e.g., the roles and profiles) of the access manager to the changed configuration file. The configuration tool may determine the current configuration of the access manager, determine an execution plan for changing the current configuration to the configuration specified in the changed configuration file, and execute the execution plan.

Some aspects also support supervisor approval of the changed configuration file and/or of the execution plan. For example, the version control system may request supervisor approval of a changed configuration file prior to allowing check-in of the changed configuration file. In another example, some embodiments may also or alternatively require supervisor approval of the changes to be applied to the existing access manager configuration prior to applying those changes. Moreover, since the version control system maintains prior versions of the configuration file, embodiments may support efficient reversion of the access manager configuration to a prior state as defined by a prior version of the configuration file.

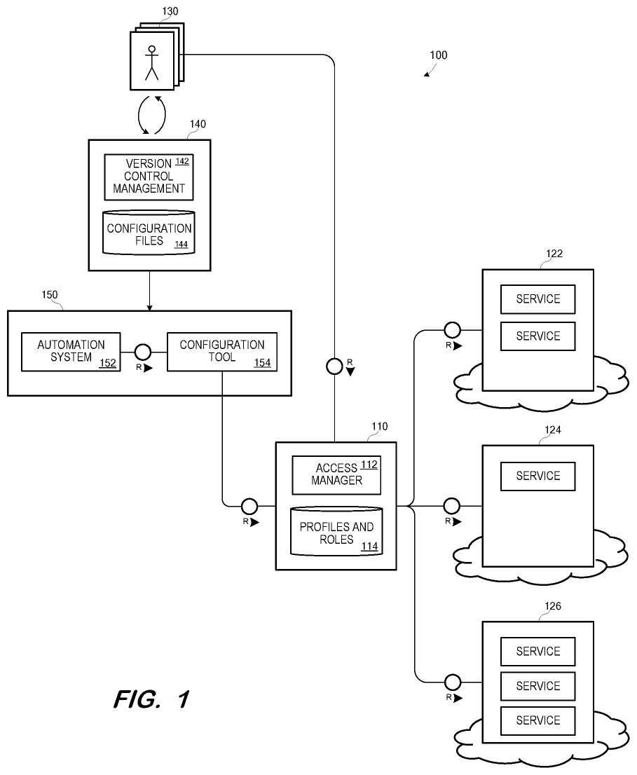

FIG. 1 is a block diagram of architecture 100 according to some embodiments. The illustrated elements of architecture 100 may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. In some embodiments, two or more elements of architecture 100 are implemented by a single computing device, and/or two or more elements of architecture 100 are co-located. One or more elements of architecture 100 may be implemented using cloud-based resources, and/or other systems which apportion computing resources elastically according to demand, need, price, and/or any other metric.

Access manager system 110 may comprise any combination of computing hardware and software suitable to provide access manager 112 and to persist profiles and roles 114. Access manager 112 may comprise program code executable to cause system 100 to perform the functions attributed herein to access manager 112. Generally, access manager 112 may provide a single entry point for managing authentications and authorizations associated with a plurality of disparate systems and services.

For example, various ones of profiles and roles 114 may be associated with various ones of systems 122, 124 and 126 and of one or more services provided by each of systems 122, 124 and 126. Each of systems 122, 124, 126 and any other system mentioned herein may comprise an on-premise server, a cloud-deployed virtual machine, or any other suitable computing system to provide a software-based service. Each of systems 122, 124, 126 is depicted upon a cloud in order to represent their elasticity and their availability via Web communication protocols, but embodiments are not limited thereto. Each of access manager 110, version control system 140 and file-based configuration system 150 may be similarly cloud-implements.

As illustrated in FIG. 1, in some embodiments any of administrator devices 130 may directly access a user interface provided by access manager 112 to create, read, update and delete profiles and roles 114. For example, an administrator may operate an administrator device 130 to execute a Web browser and to input a Uniform Resource Locator (URL) associated with access manager 112 into the Web browser. The Web Browser issues a request based on the URL to initiate communication with access manager 112, either via static Web pages or browser-executable user interface code downloaded from access manager 112. The communication includes manual specification, by the administrator, of profiles and roles, of associations between users, profiles and roles, and of associations between systems, services profiles and roles.

FIG. 1 also illustrates communication between administrator system 130 and version control system 140. Version control system 140 executes version control management 142, which may comprise any logic to support check-in and versioning of files. Version control management 142 may comprise a source code check-in system such as but not limited to GitHub. Version control system 140 may be implemented using distributed servers and storage that is known in the art.

Version control system 140 stores configuration files 144. Configuration files 144 may conform to a declarative configuration language, and each of configuration files 144 may define a desired final state consisting of profiles, roles, external systems and services, and associations therebetween, which together comprise a configuration of access manager 112. Configuration files 144 may include previously checked-in versions of a configuration file, allowing rollback to prior versions as mentioned above. Configuration files 144 may also include not-yet-checked-in versions of configuration files as is known in the art.

Automated file-based configuration system 150 includes automation system 152 and configuration tool 154. Automation system 152 detects changes to one of configuration files 144 and, automatically in response, instructs execution of configuration tool 154 to update a configuration (e.g., the roles and profiles) of access manager 112 based on the changed configuration file. The update, as instructed by automation system 152, may include determination of the current configuration of access manager 112, determination of an execution plan for changing the current configuration to the configuration specified in the changed configuration file 144, and execution of the execution plan.

The execution plan may include transformation of high-level requests into low-level (e.g., create, read, update and delete (CRUD)) operations and direct injection of the low-level operations into access manager system 110. Access manager 112 may provide a REpresentational State Transfer (REST) API which is called by configuration tool 154 to perform the direct injection. In some embodiments, configuration tool 154 comprises a generic tool which uses declarative code to describe the final state of a resource and which performs CRUD actions on the resource to accomplish the desired state, and a plug-in to the generic tool for communication via the REST API of access manager 112.

Some embodiments do not provide direct access by an administrator device 130 to a user interface of access manager 112 for the purpose of modifying profiles and roles 114. Such embodiments allow such modification to proceed only via the mechanism described above with respect to version control system 140 and file-based configuration system 150.

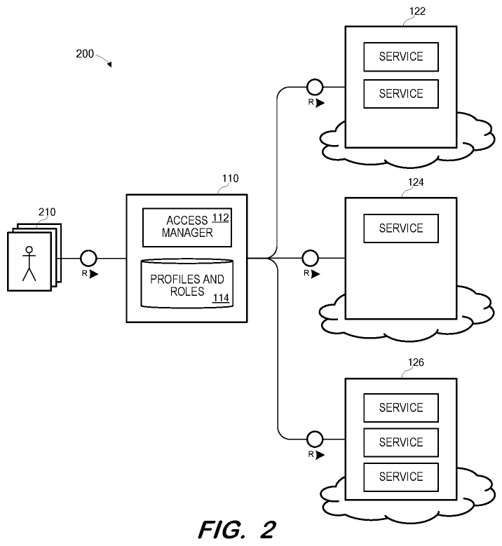

FIG. 2 illustrates run-time architecture 200 according to some embodiments. Architecture 200 includes access manager system 110 which may be configured as described above.

A user of one of user systems 210 may access an interface (e.g., Web page) of access manager 112 to request access to one of systems 122, 124 and 126 and/or a service implemented thereby. Access manager 112 authenticates the user using credentials provided by the user and determines one or more profiles and roles 114 associated with the user. Access manager 112 then determines, based on the determined profile, whether the user is authorized to access the requested system or service. If not, the request for access is denied. If so, access manager 110 authenticates the user to the requested system or service and indicates the user's role(s) thereto. The user may then access the requested system or service in a manner consistent with their role(s). In some embodiments, the user receives a session token from access manager 112 which may be used in subsequent interactions with the requested service or system.

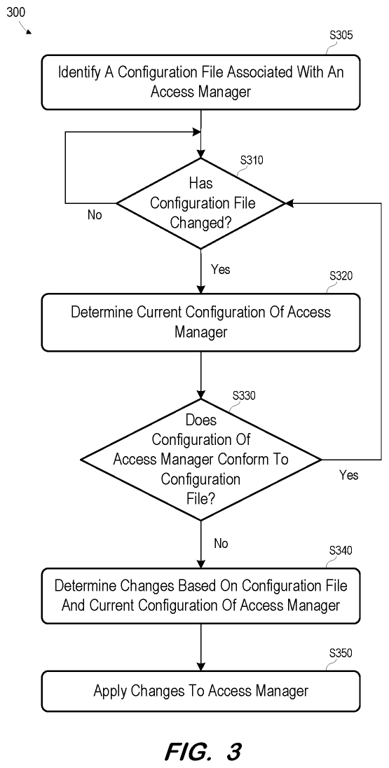

FIG. 3 comprises a flow diagram of process 300 according to some embodiments. Process 300 may be performed by an automated file-based configuration system such as system 150, but embodiments are not limited thereto. Process 300 and all other processes mentioned herein may be embodied in program code executable by one or more processing units (e.g., processor, processor core, processor thread) and read from one or more of non-transitory computer-readable media, such as a hard disk drive, a volatile or non-volatile random access memory, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Process 300 begins at S305 with the identification of a configuration file associated with an access manager. The access manager manages profiles and roles used to access disparate systems as described herein, and the configuration file is a file which defines the configuration of the access manager. The identified configuration file may be stored in a version control system. Although a single configuration file is described in process 300, it should be noted that a configuration of an access manager might be contained within several individual files. Such individual files are collectively considered a single file for purposes of process 300.

The configuration file is monitored at S310 until it is determined that the configuration file has changed. S310 may comprise monitoring a version control system which manages the configuration file. More specifically, S310 may comprise determining whether a new version of the configuration file has been checked-in to the version control system. In some examples, an administrator may check-out the configuration file, makes changes thereto, and check-in the changed version of the configuration file. In response, the checked-in changed version of the file is assigned a new version number and stored. Storage of the file with a new version number results in a determination at S310 that the configuration file has changed.

Flow proceeds from S310 to S320 once it is determined that the configuration file has changed. The current configuration of the access manager is determined at S320. In some embodiments, configuration tool 154 executes a plug-in associated with access manager 112 to communicate with access manager 112 via a REST API of access manager 112. The REST API includes interfaces usable to determine a current configuration, including current profiles and roles, of access manager 112.

Next, at S330, it is determined whether the current configuration of the access manager conforms to the changed configuration file. Since the configuration file defines a respective configuration, S330 may simply include determining whether the configuration defined in the changed configuration file is different from the current configuration of the access manager determined at S320. If the current configuration of the access manager conforms to the changed configuration file (i.e., no differences exist), then flow returns to S310 to continue monitoring for changes to the configuration file.

If the determination at S330 is negative, changes are determined at S340 based on the configuration file and the current configuration of the access manager. The determined changes may comprise a set of change operations required to change the current configuration to the configuration defined by the changed configuration file. The set of change operations may be considered an execution plan.

Once the changes have been determined, the changes are applied to the access manager at S350. Application of the changes at S350 may comprise executing a set of change operations determined at S340 upon the profiles and roles of the access manager. In some embodiments, the operations may be executed via corresponding calls to the aforementioned REST API of the access manager. Once the changes have been applied, flow may return to S310 to continue monitoring of the configuration file associated with the access manager.

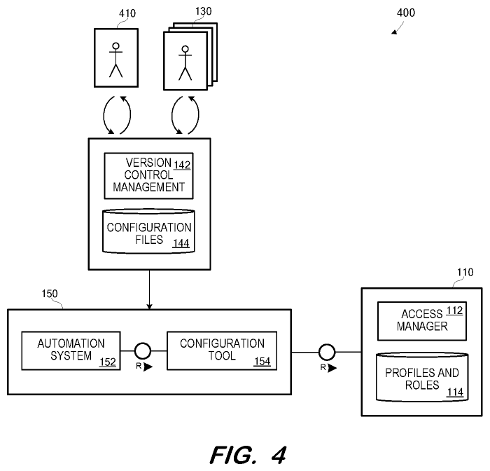

FIG. 4 illustrates architecture 400 including approval system 410. Incorporating approvals into some embodiments may reduce a chance of errors which might otherwise occur. The other elements of architecture 400 may be implemented as described above with respect to similarly-numbered elements of architectures 100 and 200.

According to some embodiments, architecture 400 implements process 300. However, unlike the above description of process 300, a request to check-in a changed configuration file 144 triggers an approval process. For example, version control management 142 may receive a check-in request from a system 130. In response, version control management 142 may transmit a request to approval system 410 (which may simply be a system operated by a user having authority to approve configuration file check-ins) to review and approve the changed configuration file associated with the check-in. If the file is reviewed and approved by the user operating system 410, version control management 142 assigns a new version number to the changed file and stores the file. As described above, such storage may trigger an affirmative determination at S320 of process 300.

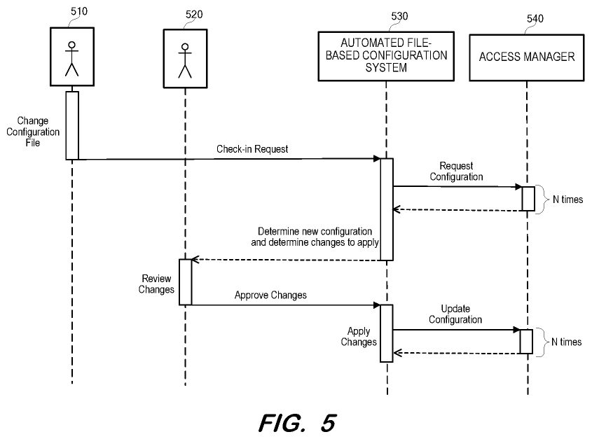

FIG. 5 is a sequence diagram of a process to approve of and apply configuration changes according to some embodiments. The process begins with user 510 changing a configuration file as described herein. The configuration file defines a configuration of an access manager and may be managed by a version control system (not shown).

User 510 submits a request to check-in the changed configuration file to the version control system. As illustrated in FIG. 5, the request is detected by automated file-based configuration system 530. In response to detecting the request, system 530 communicates with access manager 540 (with which the configuration file is associated) to request and receive the current configuration of access manager 540.

Next, automated file-based configuration system 530 determines and validates the new configuration defined by the changed configuration file. System 530 also determines, based on the new configuration and the current configuration of access manager 540, changes which, if applied to the current configuration, would result in the new configuration. The changes may comprise a set of CRUD operations, for example.

The changes are transmitted to a user 520 with approval authority. The user 520 reviews the changes and may issue an approval thereof. In some embodiments, user 520 is notified of the existence of the changes and performs steps to accesses the determined changes in order to perform the review. The approval is received by system 530.

System 530 operates to apply the changes to access manager 540. Application of the changes results in updating the configuration of the access manager to the new configuration defined by the changed configuration file. Application of the changes may proceed by instructing access manager 540 to execute corresponding CRUD operations as described herein.

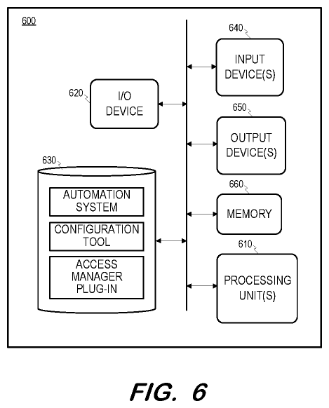

FIG. 6 is a block diagram of a computing system according to some embodiments. System 600 may comprise a general-purpose computing apparatus and may execute program code to perform any of the processes or functions described herein. System 600 may be implemented by a standalone computing device, a distributed cloud-based server, or other system and may include other unshown elements according to some embodiments.

System 600 includes processing unit(s) 610 operatively coupled to I/O device 620, data storage device 630, one or more input devices 640, one or more output devices 650 and memory 660. I/O device 620 may facilitate communication with external devices, such as an external network, the cloud, or a data storage device. Input device(s) 640 may comprise, for example, a keyboard, a keypad, a mouse or other pointing device, a microphone, knob or a switch, an infra-red (IR) port, a docking station, and/or a touch screen. Input device(s) 640 may be used, for example, to enter information into system 600. Output device(s) 650 may comprise, for example, a display (e.g., a display screen) a speaker, and/or a printer.

Data storage device 630 may comprise any appropriate persistent storage device, including combinations of magnetic storage devices (e.g., magnetic tape, hard disk drives and flash memory), optical storage devices, Read Only Memory devices, and Random Access Memory (RAM) devices, while memory 660 may comprise a RAM device.

Data storage device 630 stores program code executed by processing unit(s) 610 to cause system 600 to implement any of the components and execute any one or more of the processes described herein. Embodiments are not limited to execution of these processes by a single computing device. Data storage device 630 may also store data and other program code for providing additional functionality and/or which are necessary for operation of system 600, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remotely from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processing unit to execute program code such that the computing device operates as described herein.

Embodiments described herein are solely for the purpose of illustration. Those in the art will recognize other embodiments may be practiced with modifications and alterations to that described above.

What is claimed is:

1. A method comprising:
identifying a file defining a configuration associated with an access manager, the access manager storing roles and profiles for accessing a plurality of computing systems;
determining that the file has changed; and
in response to the determination:
determining a current configuration of the access manager;
determining a new configuration defined by the changed file;
determining configuration changes based on the current configuration and the new configuration; and
instructing the access manager to apply the configuration changes.

2. A method according to claim 1, wherein the file is stored by a version control system and the changed file is a new version of the file, and
wherein determining that the file has changed comprises detecting a check-in of the changed file to the version control system.

3. A method according to claim 2, wherein the check-in is requested by a first user and is approved by a second user prior to check-in of the changed file to the version control system.

4. A method according to claim 2, further comprising:
receiving approval of the configuration changes,
wherein the access manager is instructed to apply the configuration changes in response to receipt of the approval.

5. A method according to claim 1, wherein the check-in is requested by a first user and is approved by a second user prior to check-in of the changed file to the version control system.

6. A method according to claim 1, further comprising:
receiving approval of the configuration changes,
wherein the access manager is instructed to apply the configuration changes in response to receipt of the approval.

7. A non-transitory computer-readable medium storing program code executable by a processing unit to cause a computing system to:
identify a file defining a configuration associated with an access manager, the access manager storing roles and profiles for accessing a plurality of cloud providers;
determine that the file has changed; and
in response to the determination:
determine a current configuration of the access manager;
determine a new configuration defined by the changed file;
determine configuration changes based on the current configuration and the new configuration; and
instruct the access manager to apply the configuration changes.

8. A medium according to claim 7, wherein the file is stored by a version control system and the changed file is a new version of the file, and
wherein determining that the file has changed comprises detecting a check-in of the changed file to the version control system.

9. A medium according to claim 8, wherein the check-in is requested by a first user and is approved by a second user prior to check-in of the changed file to the version control system.

10. A medium according to claim 8, the computer-readable medium storing program code executable by a processing unit to cause a computing system to:
receive approval of the configuration changes,
wherein the access manager is instructed to apply the configuration changes in response to receipt of the approval.

11. A medium according to claim 7, wherein the check-in is requested by a first user and is approved by a second user prior to check-in of the changed file to the version control system.

12. A medium according to claim 7, the computer-readable medium storing program code executable by a processing unit to cause a computing system to:
receive approval of the configuration changes,
wherein the access manager is instructed to apply the configuration changes in response to receipt of the approval.

13. A system comprising:
one or more processing units; and
a memory storing program code executable by the one or more processing units to cause the system to:
identify a file defining a configuration associated with an access manager, the access manager storing roles and profiles for accessing a plurality of cloud providers;
determine that the file has changed; and
in response to the determination:
determine a current configuration of the access manager;
determine a new configuration defined by the changed file;
determine configuration changes based on the current configuration and the new configuration; and
instruct the access manager to apply the configuration changes.

14. A system according to claim 13, wherein the file is stored by a version control system and the changed file is a new version of the file, and
wherein determining that the file has changed comprises detecting a check-in of the changed file to the version control system.

15. A system according to claim 14, wherein the check-in is requested by a first user and is approved by a second user prior to check-in of the changed file to the version control system.

16. A system according to claim 14, the memory storing program code executable by the one or more processing units to cause the system to:
receive approval of the configuration changes,
wherein the access manager is instructed to apply the configuration changes in response to receipt of the approval.

17. A system according to claim 13, wherein the check-in is requested by a first user and is approved by a second user prior to check-in of the changed file to the version control system.

18. A system according to claim 13, the memory storing program code executable by the one or more processing units to cause the system to:
receive approval of the configuration changes,
wherein the access manager is instructed to apply the configuration changes in response to receipt of the approval.
